(19) United States
(12) Patent Application Publication
(10) Pub. No.: US 2016/0121996 A1
(43) Pub. Date: May 5, 2016

(54) Spoiler for an Aircraft Bay

(71) Applicant: The Boeing Company, Chicago, IL (US)

(72) Inventors: James Vincent Eveker, St. Louis, MO (US); Patrick Dale Huhman, St. Peters, MO (US); Cindy Lee Crites, O'Fallon, MO (US)

(73) Assignee: The Boeing Company, Chicago, IL (US)

(21) Appl. No.: 14/203,636

(22) Filed: Mar. 11, 2014

(51) Int. Cl. B64C 5/12; B64C 23/00

(52) U.S. Cl. CPC B64C 5/12; B64C 23/005

(57) ABSTRACT

A method for managing an airflow of an aircraft. A spoiler is moved into the airflow passing a bay of the aircraft when the bay is open. The airflow moving relative to the bay is changed to form a desired airflow using louvers physically associated with a frame system in the spoiler.

### BACKGROUND INFORMATION

1. Field

The present disclosure relates generally to aircraft and, in particular, to an airflow management system. Still more particularly, the present disclosure relates to a method and apparatus for managing an airflow moving past a bay in an aircraft

2. Background

Many types of aircraft have one or more bays that may open during different phases of flight. For example, military aircraft may have a weapons bay on the underside of the fuselage of the military aircraft. The weapons bay may be a cavity or a space inside the military aircraft that is covered by one or more doors. The weapons bay allows for the deployment of a payload located within the weapons bay. The payload may be, for example, equipment, stores, munitions, other types of payload.

When the doors of the weapons bay are closed, the surface of the aircraft has a desired shape and smoothness that enhances aerodynamic performance as well as other characteristics of the aircraft. Other characteristics may include, for example, stealthiness of the aircraft. When the doors of the weapons bay are open during flight, the airflow does not move over the aircraft in a desired manner. Instead, the opening of the doors often results in an unstable airflow that buffets aircraft structures, the payload, or both.

For example, when the doors are open, a region called a shear layer is created such that the airflow abruptly transitions from a low speed flow of air inside of a cavity to high speed flow of air outside of the cavity of the weapons bay. This shear layer may result in rotating pockets of airflow referred to as vortices. The vortices remain on the aft wall of the cavity causing vibrations.

The vibrations may cause undesired noise in the weapons bay. For example, the vibrations may result in high levels of resonance and acoustic levels within the weapons bay. These vibrations may adversely affect the structures or parts of the aircraft such that the aircraft does not perform in a desired manner.

An undesired noise may reduce performance characteristics such as stealthiness of the aircraft and may result in needed aircraft structures that have increases in weight, which also reduce aircraft performance. Further, the unstable airflow may cause a payload that is separating from the aircraft to become uncontrollable or contact the aircraft after release. This type of contact may cause inconsistencies in the structure of the aircraft, cause the payload to perform in an undesired manner, or result in some other undesirable event. For example, the payload may become uncontrollable with respect to directing the payload to a target even if contact does not happen with the aircraft. For example, a payload being delivered to a location on the ground may be released and designed to have a trajectory to reach the location. If the payload becomes uncontrollable, contacts the aircraft, or both after being released, then the payload may not follow the trajectory needed to reach the location.

A spoiler may be used to reduce this undesired airflow. Currently used spoilers, however, may generate more turbulence than desired in the airflow while attempting to reduce undesired noise in the weapons bay. This type of turbulence may not provide a desired level of performance for different characteristics of the aircraft.

Therefore, it would be desirable to have a method and apparatus that take into account at least some of the issues discussed above, as well as other possible issues.

### SUMMARY

An embodiment of the present disclosure provides an apparatus. The apparatus comprises a frame system and louvers. The frame system is configured to move relative to a bay in an aircraft. The louvers are physically associated with the frame system. The louvers are configured to change an airflow moving relative to the bay when the bay is open to form a desired airflow.

Another embodiment of the present disclosure provides an aircraft airflow management system comprising a group of frames and louvers. The group of frames are configured to move between a stowed position in a bay of the aircraft and an active position outside the bay of the aircraft. The louvers are physically associated with the group of frames. The louvers are configured to change an airflow relative to the bay after the louvers are in the airflow outside of the bay in a desired manner when the bay is open to form a desired airflow and the group of frames are in the active position. The desired airflow results in at least one of a desired level of noise, preventing a payload from becoming uncontrollable, or avoiding contact between the aircraft and the payload exiting the bay of an aircraft in flight.

Yet another embodiment of the present disclosure provides a method for managing an airflow for an aircraft. A spoiler is moved into the airflow passing a bay of the aircraft when the bay is open. The airflow moving relative to the bay is changed to form a desired airflow using louvers physically associated with a frame system in the spoiler.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of an aircraft with a bay in an open position in accordance with an illustrative embodiment;

FIG. 3 is an illustration of an airflow management system for an aircraft in accordance with an illustrative embodiment;

FIG. 4 is an illustration of an enlarged view of a frame system in accordance with an illustrative embodiment;

FIG. 5 is an illustration of a portion of a frame system in accordance with an illustrative embodiment;

FIG. 6 is an illustration of a laminar airflow redirected in a desired direction in accordance with an illustrative embodiment;

FIG. 7 is an illustration of a cross-section of louvers in a portion of a frame in accordance with an illustrative embodiment;

FIG. 8 is an illustration of a movement system in accordance with an illustrative embodiment;

FIG. 9 is an illustration of a movement system in accordance with an illustrative embodiment;

FIG. 10 is an illustration of a frame that moves about an axis in accordance with an illustrative embodiment;

FIG. 11 is another illustration of a frame that moves about another axis in accordance with an illustrative embodiment;

FIG. 12 is an illustration of cross-sections of louvers in accordance with an illustrative embodiment;

FIG. 13 is an illustration of an airflow management system in the form of a block diagram in accordance with an illustrative embodiment;

FIG. 14 is an illustration of a flowchart of a process for managing airflow for an aircraft in accordance with an illustrative embodiment;

FIG. 15 is an illustration of a flowchart of a process for managing an airflow for an aircraft using an airflow management system in accordance with an illustrative embodiment;

FIG. 16 is an illustration of an aircraft manufacturing and service method in the form of a block diagram in accordance with an illustrative embodiment; and

FIG. 17 is an illustration of an aircraft in the form of a block diagram in which an illustrative embodiment may be implemented.

### DETAILED DESCRIPTION

The illustrative embodiments recognize and take into account one or more different considerations. For example, the illustrative embodiments recognize and take into account that currently used devices introduced into an airflow moving past a bay in an aircraft often cause more turbulence than desired. The illustrative embodiments also recognize and take into account that currently used spoilers are static in design. In other words, the illustrative embodiments recognize and take into account that a spoiler for the bay of an aircraft may be designed to take into account the characteristics of the bay and the payload.

The illustrative embodiments recognize and take into account that a spoiler designed for a particular bay and payload may not perform as well in reducing undesired airflow when placed in a different bay. Further, even when used in the same bay, when the payload is changed, the spoiler may not reduce undesired airflow as much as desired.

Further, the illustrative embodiments recognize and take into account that currently used spoilers are unable to dynamically adapt to changes in the environment around the aircraft or changes within the bay cavity during flight. This may include, for example, different speeds, altitudes, temperatures, and other environmental parameters that may change. As another example when objects are sequentially released over time, the configuration of the cavity changes, which may change the manner in which air flows in the cavity. In other words, when objects are released the manner in which airflows in the cavity may change. With these types of changes, the illustrative embodiments recognize and take into account that a spoiler may not change the airflow in a desired manner to avoid reductions in performance, noise generated by the airflow, or both.

Thus, the illustrative embodiments provide a method and apparatus for managing an airflow for an aircraft. In one illustrative example, an apparatus comprises a frame system and louvers. These components form a spoiler. The frame system is configured to move relative to a bay in an aircraft. The louvers are physically associated with the frame system and are configured to change an airflow moving relative to the bay when the bay is open to form a desired airflow. In the illustrative examples, the change in the airflow is in a direction relative to the surface of the aircraft. This change in airflow may result in undesired airflow in which turbulence, vortices, and other undesirable types of airflow are reduced.

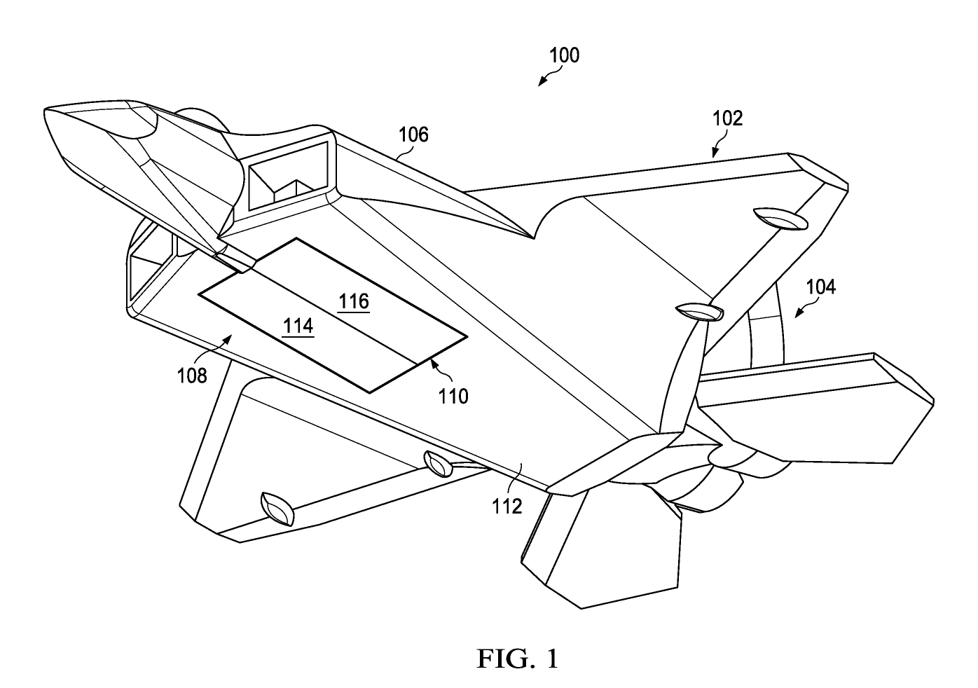

With reference now to the figures and, in particular, with reference to FIG. 1, an illustration of an aircraft is depicted in accordance with an illustrative embodiment. In this depicted example, aircraft 100 is shown. As depicted, aircraft 100 is a tactical fighter having wings 102, tail 104, and fuselage 106.

In this illustrative example, aircraft 100 has bay 108 in the form of a weapons bay in fuselage 106. In this illustrative example, opening 110 for bay 108 is located on lower outer mold line 112 of aircraft 100. Opening 110 is covered by door 114 and door 116 in this illustrative example.

As depicted, outer mold line 112 is designed to provide one or more desired performance parameters for aircraft 100. These performance parameters may include, for example, one or more of stealthiness, drag, noise, fuel efficiency, and other suitable types of parameters regarding the performance of aircraft 100.

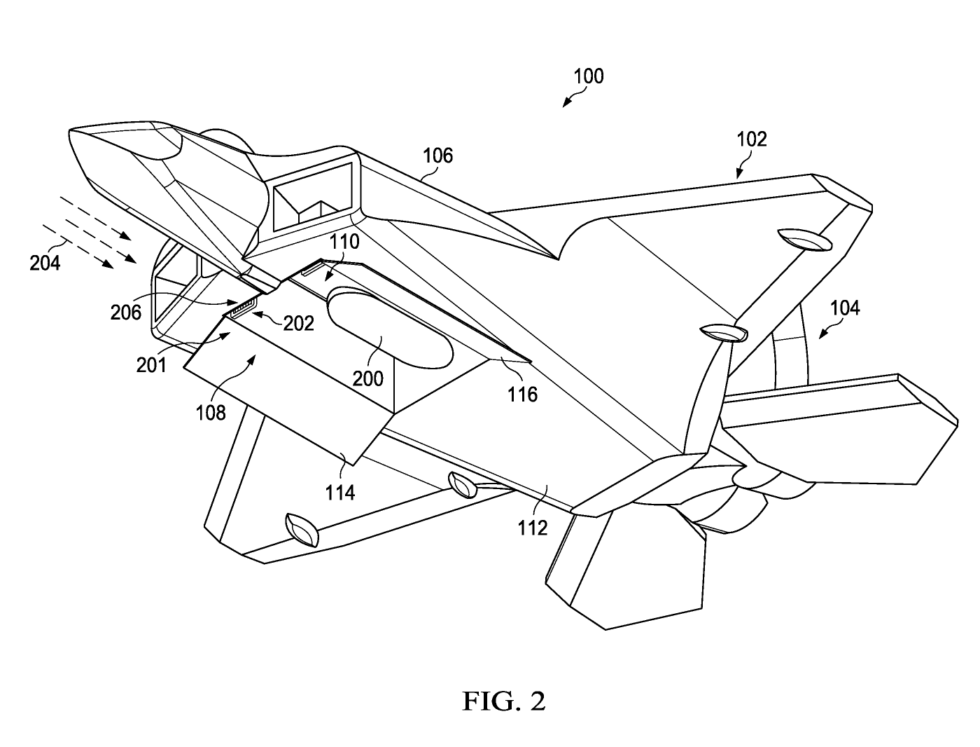

Turning to FIG. 2, an illustration of an aircraft with a bay in an open position is depicted in accordance with an illustrative embodiment. In this illustrative example, door 114 and door 116 are in an open position exposing opening 110 in bay 108. In this view of aircraft 100, payload 200 is seen in cavity 201 in bay 108. Payload 200 is one or more objects that may be separated from aircraft 100. Payload 200 may take various forms. For example, payload 200 may be equipment, sensors, supplies, munitions, weapons, and other suitable types of payload.

Also seen in this view is airflow management system 202. Airflow management system 202 is used to manage airflow 204 moving relative to bay 108 when bay 108 is open. As shown, airflow management system 202 is in stowed position 206.

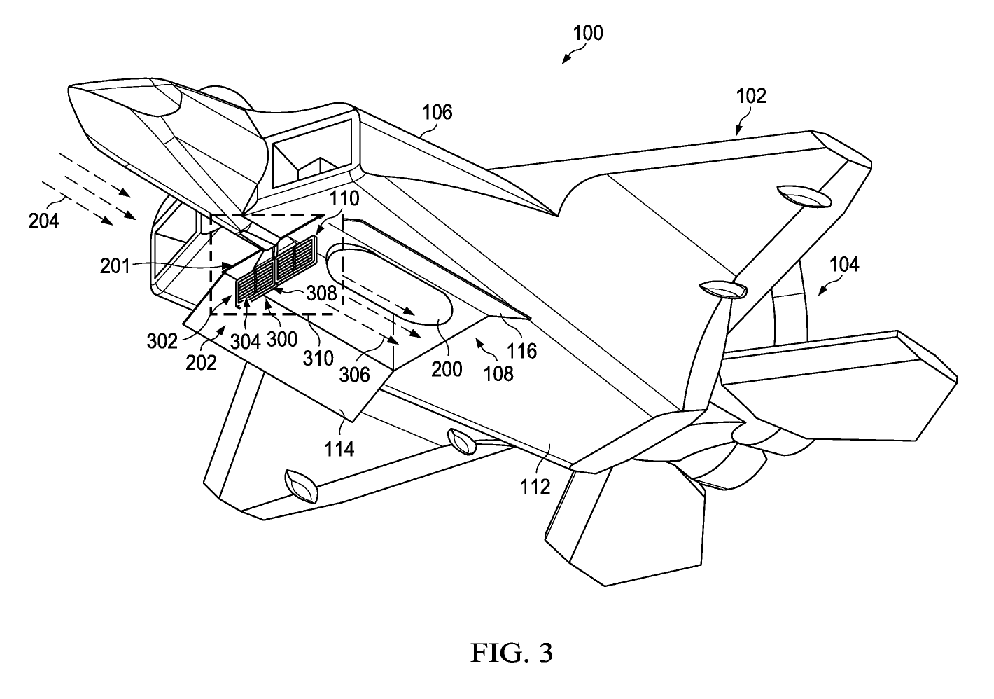

With reference next to FIG. 3, an illustration of an airflow management system for an aircraft is depicted in accordance with an illustrative embodiment. As depicted, airflow management system 202 is shown in active position 300. In particular, frame system 302 in airflow management system 202 is configured to move between stowed position 206 and active position 300.

In this example, louvers 304 are shown as physically associated with frame system 302. Louvers 304 are configured to change airflow 204 moving relative to bay 108 when bay 108 is open to form desired airflow 306 when airflow 204 passes through louvers 304 in frame system 302.

When one component is “physically associated” with another component, the association is a physical association in the depicted examples. For example, a first component, louvers 304, may be considered to be physically associated with a second component, frame system 302, by at least one of being secured to the second component, bonded to the second component, mounted to the second component, welded to the second component, fastened to the second component, or connected to the second component in some other suitable manner. The first component also may be connected to the second component using a third component. The first component may also be considered to be physically associated with the second component by being formed as part of the second component, extension of the second component, or both.

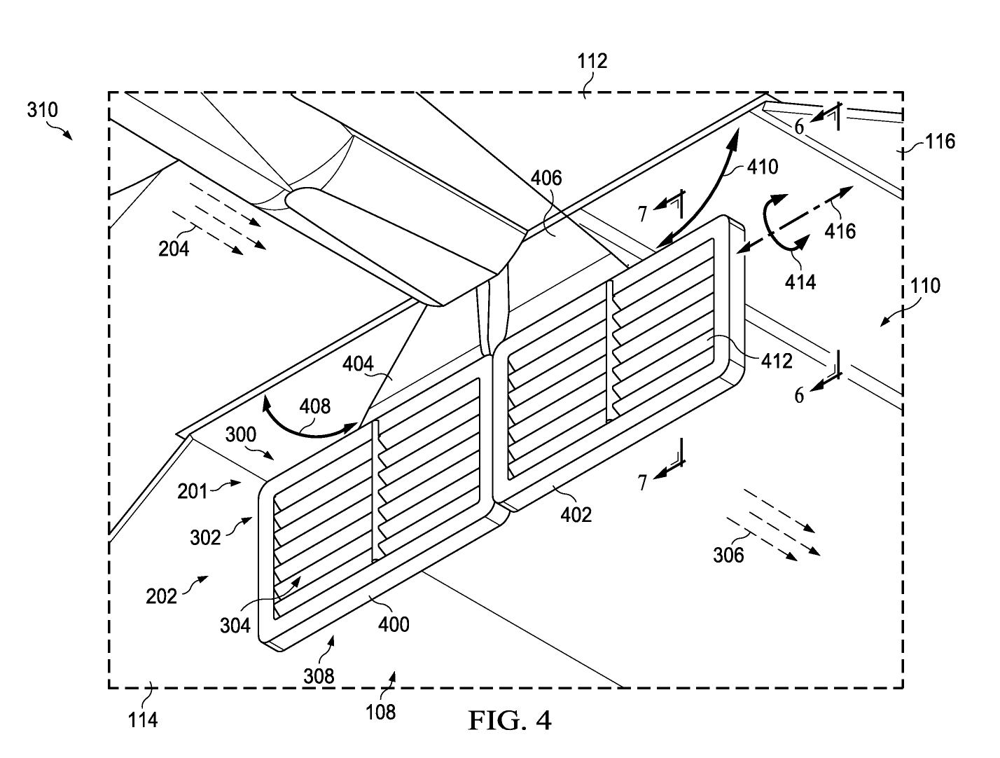

In the illustrative example, frame system 302 and louvers 304 form spoiler 308 for aircraft 100. An enlarged view of spoiler 308 in section 310 is described with respect to FIG. 4.

With reference next to FIG. 4, an illustration of an enlarged view of a frame system is depicted in accordance with an illustrative embodiment. In this figure, an enlarged view of section 310 with spoiler 308 is depicted.

As can be seen, frame system 302 in spoiler 308 is comprised of frame 400, frame 402, connector 404, and connector 406. Connector 404 is physically associated with frame 400 and connector 406 is physically associated with frame 402. Connector 404 with frame 400 may be rotated in the direction of arrow 408. Connector 406 with frame 402 may be rotated in the direction of arrow 410.

As can be seen, louvers 304 are located within frame 400 and frame 402. Louvers 304 are movable in these illustrative examples but may be fixed in other examples. For example, louver 412 in louvers 304 may be rotated in the direction of arrow 414 about axis 416 extending through louver 412.

The movement of louvers 304 may change the direction of airflow 204 moving relative to bay 108 when bay 108 is open to form desired airflow 306 for airflow 204 when airflow 204 passes through louvers 304 in frame 400 and frame 402 in frame system 302. Louvers 304 may be moved while aircraft 100 is at least one of on the ground or in the air. In other words, louvers 304 may be moved while the aircraft is stationary, moving on the ground, during flight, or some combination thereof. In other words, louvers 304 may be moved dynamically during operation of aircraft 100.

As used herein, the phrase “at least one of,” when used with a list of items, means different combinations of one or more of the listed items may be used and only one of each item in the list may be needed. In other words, “at least one of” means any combination of items and number of items may be used from the list but not all of the items in the list are required. The item may be a particular object, thing, or a category. For example, without limitation, “at least one of item A, item B, or item C” may include item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations.

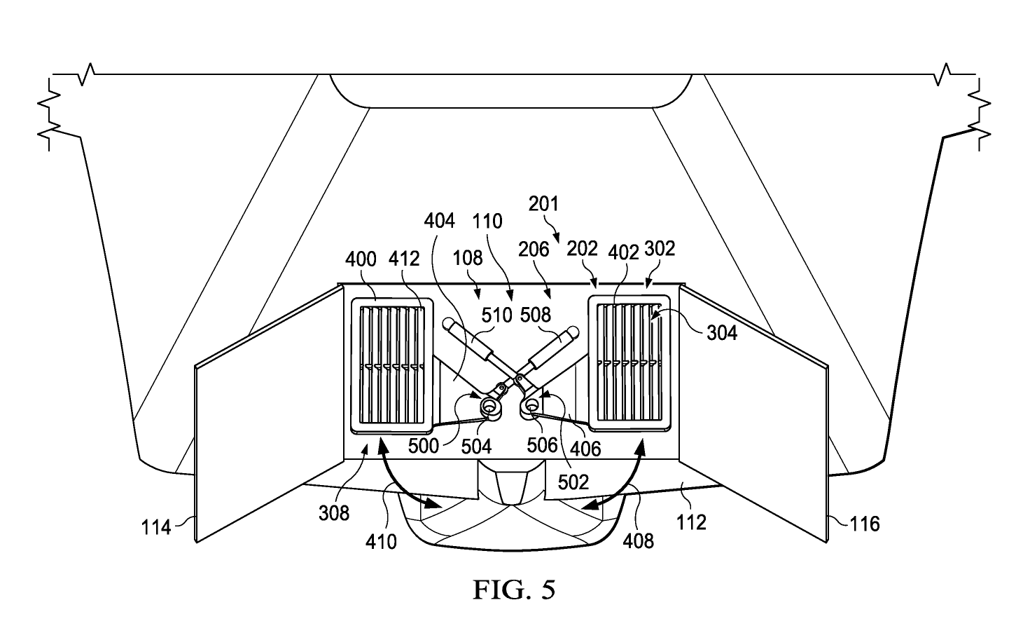

Turning next to FIG. 5, an illustration of a portion of frame system 302 is depicted in accordance with an illustrative embodiment. As depicted, an illustration of a portion of frame system 302 is shown. In this view, connector 404 has channel 500, and connector 406 has channel 502. Channel 500 may receive rod 504, and channel 502 may receive rod 506. Rod 504 and rod 506 are structures about which connector 404 with frame 400 may rotate in the direction of arrow 410, and connector 406 with frame 402 may rotate in the direction of arrow 408 to move between a stowed position and an active position, or other positions in between.

Connector 404 is connected to link 508 and connector 406 is connected to link 510, which may move to cause rotation of connector 404 and frame 400 about rod 504 in the direction of arrow 410 and may cause rotation of connector 406 and frame 402 about rod 506 in the direction of arrow 408. Link 508 and link 510 may be connected to a motor, actuator, or some other movement system (not shown).

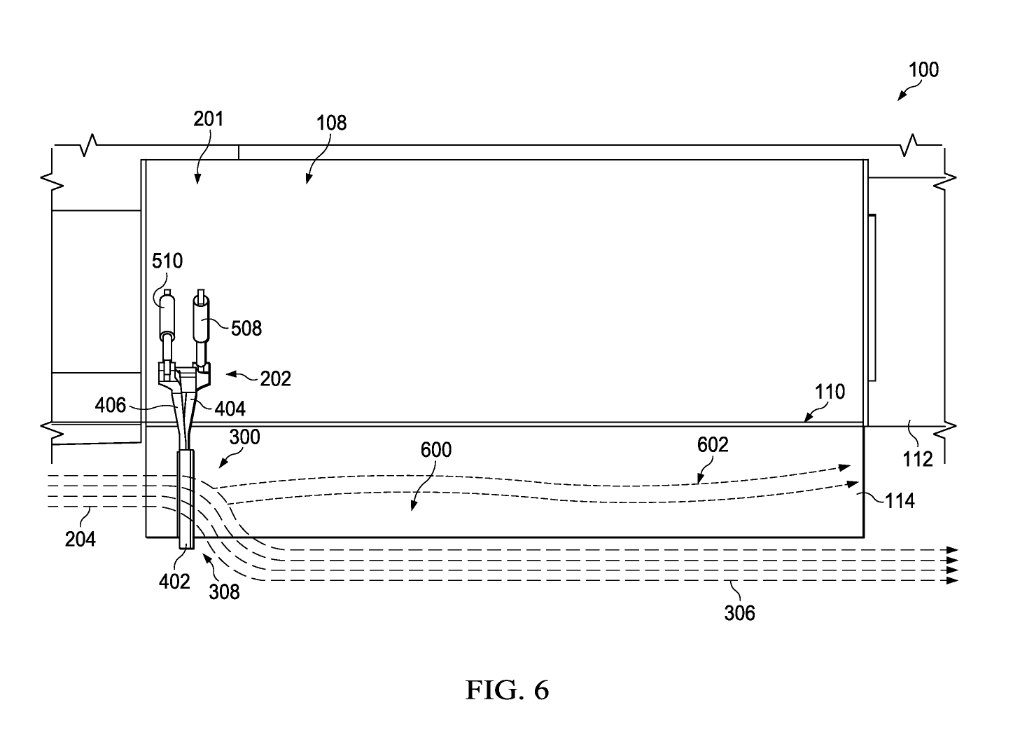

Turning next to FIG. 6, an illustration of a laminar airflow redirected in a desired direction is depicted in accordance with an illustrative embodiment. In this illustrative example, a cross-sectional view of a portion of aircraft 100 with spoiler 308 taken along lines 6-6 in FIG. 4 is shown.

In this illustrative example, airflow 204 is a laminar airflow. A laminar airflow is a substantially uninterrupted flow of fluid, such as air, near a solid, such as lower outer mold line 112. With a laminar airflow, the direction of the flow of the fluid remains substantially constant at every point in the flow of the fluid. This is in contrast to a turbulent flow in which the fluid flows such that the velocity at any given point in the flow of the fluid may vary erratically in magnitude and direction.

In this illustrative example, the redirection of airflow 204 to form desired airflow 306 pushes airflow 204 away from opening 110 of bay 108 while maintaining airflow as a substantially laminar airflow to form desired airflow 306 in this illustrative example. As can be seen, pocket 600 is formed. In this manner, an undesired turbulence in pocket 600 and cavity 201 within bay 108 may be reduced. With spoiler 308, airflow 204 moves around bay 108 rather than into bay 108.

Desired airflow 306 is in contrast to undesired airflow 602. Undesired airflow 602 includes turbulence and may result in vortices and other undesired flow of air within bay 108. This type of airflow is currently caused when spoilers are not used, spoilers are solid, or by spoilers that use holes.

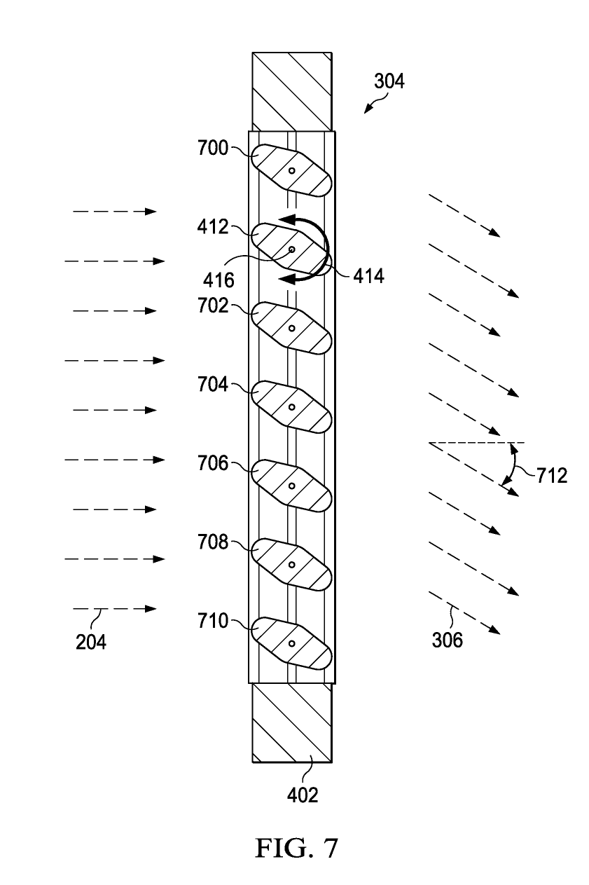

With reference next to FIG. 7, an illustration of a cross-section of louvers in a portion of a frame is depicted in accordance with an illustrative embodiment. In this figure, a cross-sectional view of louvers 304 in a portion of frame 402 is shown taken along lines 7-7 in FIG. 4.

As depicted in this view, louvers 304 include louver 700, louver 412, louver 702, louver 704, louver 706, louver 708, and louver 710. At least in this illustrative example, the louvers change the direction of airflow 204 to form desired airflow 306 when airflow 204 passes through louvers 304 shown in this view. In this example, the direction of airflow 204 is changed by angle 712 to form desired airflow 306.

In particular, airflow 204 is directed away from lower outer mold line 112 of aircraft 100 in FIG. 1. The direction of airflow 204 to form desired airflow 306 may reduce turbulence, vortexes, and other undesirable types of airflow within bay 108. For example, airflow 204 may be directed at an angle away from lower outer mold line 112 of aircraft 100 to form desired airflow 306. Additionally, desired airflow 306 also may reduce the possibility that payload 200 may become uncontrollable, contact aircraft 100 or both after being released from aircraft 100. In other words, payload 200 becoming uncontrollable and/or contact between aircraft 100 and payload 200 may be avoided when payload 200 is released from aircraft 100 and exits bay 108 of aircraft 100 during flight.

In this illustrative example, desired airflow 306 is a laminar airflow and may be referred to as a redirected laminar airflow. This type of airflow generated using spoiler 308 with frame system 302 and louvers 304 in frame system 302 is desirable in contrast to a turbulent airflow. Currently used spoilers that push the shear layer away from the cavity opening may generate a turbulent airflow which is undesirable in the illustrative examples.

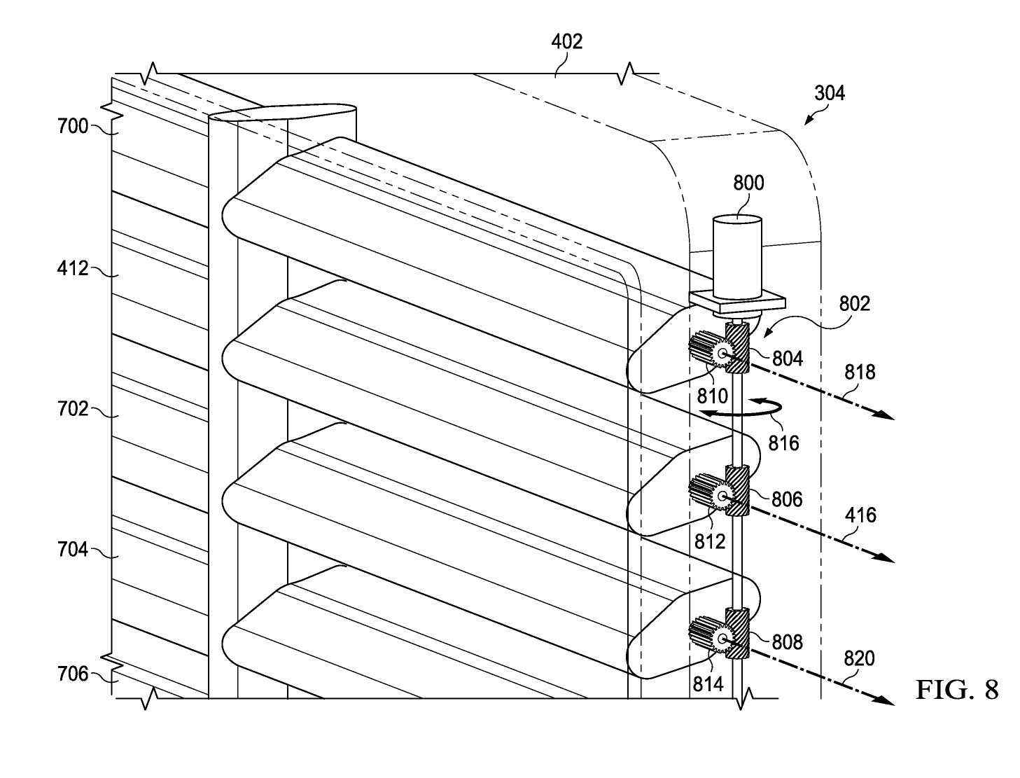

With reference to FIG. 8, an illustration of a movement system is depicted in accordance with an illustrative embodiment. In this figure, a phantom view of frame 402 in the direction of lines 8-8 in FIG. 4 is shown.

In this exposed view, motor 800 and worm gear system 802 are seen. Worm gear system 802 is an example of a movement system that may be used to move louvers 304.

As seen in this view, worm gear 804, worm gear 806, and worm gear 808 are connected to motor 800. Also, worm gear 804 engages positioning gear 810 on louver 700; worm gear 806 engages positioning gear 812 on louver 412, positioning gear 810 on louver 412, and worm gear 808 engages positioning gear 814 on louver 702. In this illustrative example, rotation of worm gear system 802 in the direction of arrow 816 causes rotation of louver 700 about axis 818, louver 412 about axis 416, and louver 702 to about axis 820.

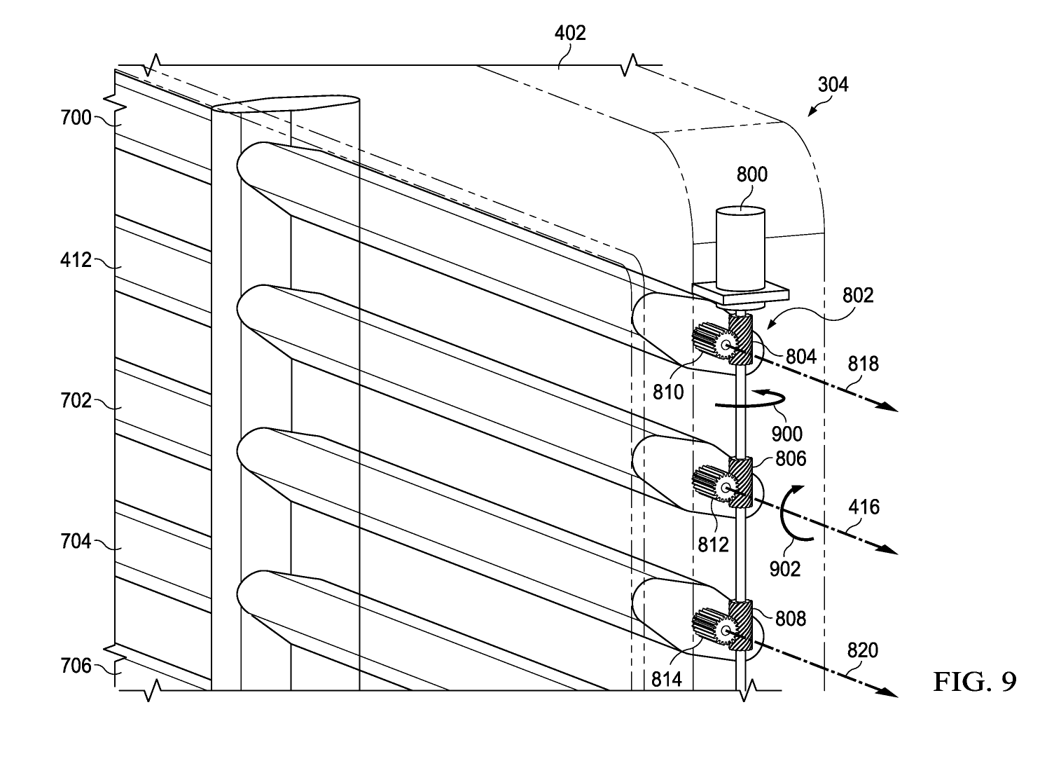

Turning next to FIG. 9, an illustration of a movement system is depicted in accordance with an illustrative embodiment. As shown, worm gear system 802 has rotated in the direction of arrow 900. This movement causes rotation of louvers 304 about their respective axes in the direction of arrow 902.

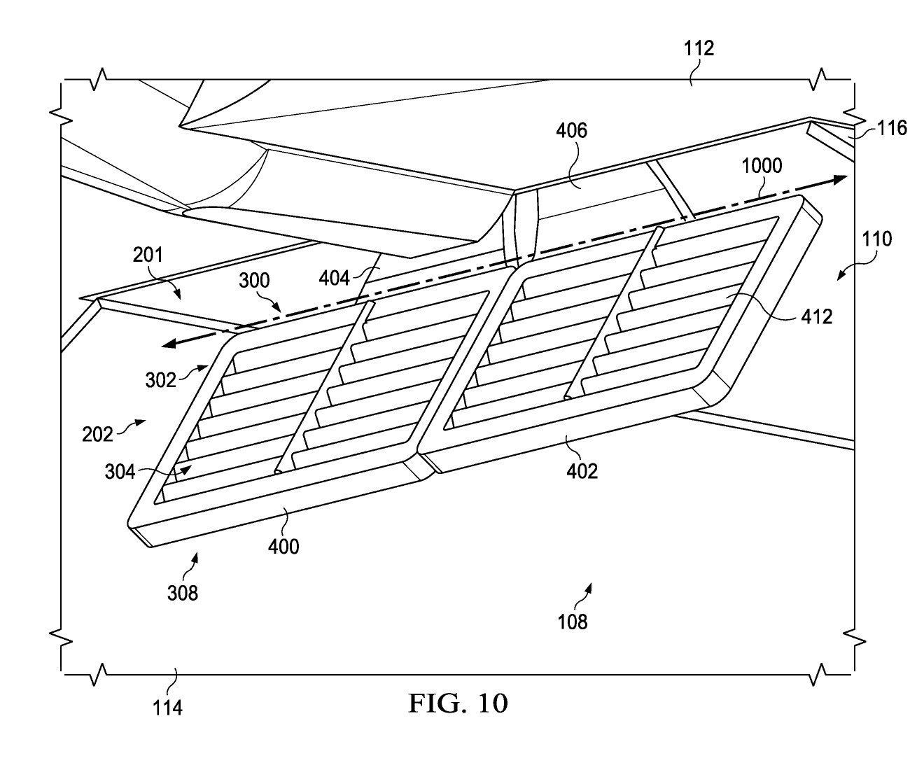

In FIG. 10, an illustration of a frame that moves about an axis is depicted in accordance with an illustrative embodiment. In addition to movement of louvers 304 within frame system 302, frame system 302 also may move about a number of axes to move to a desired orientation when frame system 302 is outside of bay 108.

In this illustrative example, frame 400 and frame 402 may rotate about axis 1000. This rotational movement occurs where frame 400 is connected to connector 404 and frame 402 is connected to connector 406. This type of movement may be implemented using any suitable type of movement system such as a motor, an actuator, and other suitable components.

Turning next to FIG. 11, another illustration of a frame that moves about another axis is depicted in accordance with an illustrative embodiment. As depicted in this example, frame 400 may rotate about axis 1100. Frame 402 may rotate about axis 1102.

The movement in FIGS. 10-11 may be implemented using any suitable type of movement system. The movement system may include components such as, for example, at least one of a motor, an actuator, a pulley, care system, and other suitable components. The movement of frame 400 and frame 402 in frame system 302 may provide for additional capabilities to redirect airflow 204 to form desired airflow 306. Further, other types of movement of frame 400 and frame 402 also may occur. In another illustrative example, movement of these frames may be linear rather than rotational depending on the particular implementation. Further, multiple types of movement may be present about or along one or more axes depending on the particular implementation.

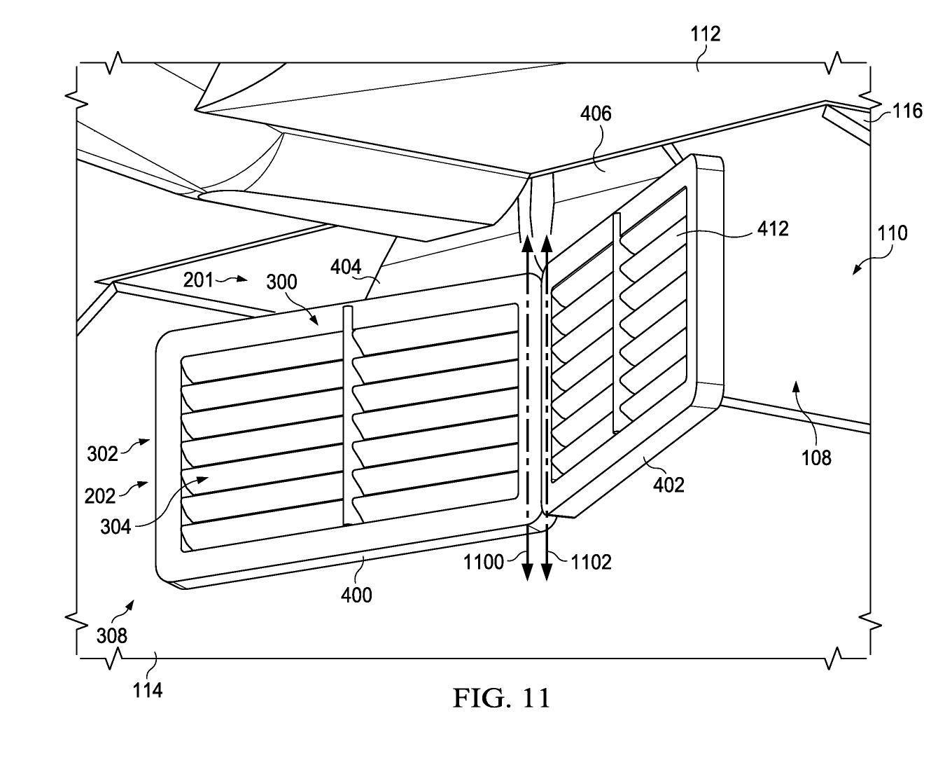

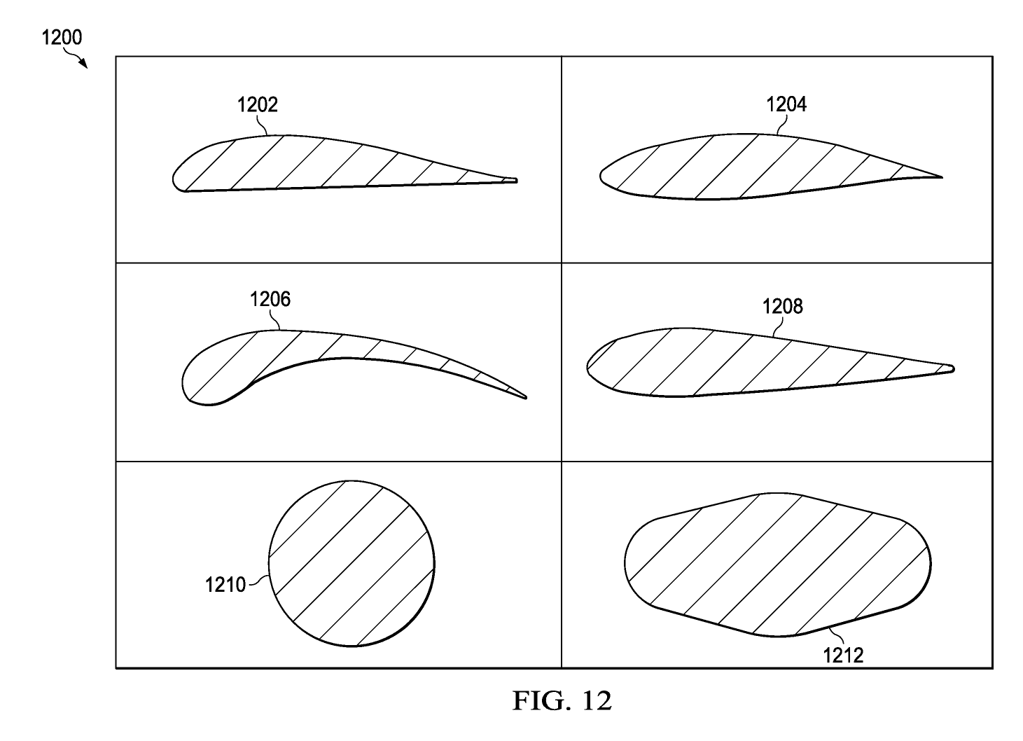

Turning next to FIG. 12, an illustration of cross-sections of louvers is depicted in accordance with an illustrative embodiment. Louvers 304 may take various forms and have different cross-sections. In the illustrative examples, a louver may be an elongate member that may change the airflow. In particular, a louver may be an elongate member that may change the direction of airflow as the airflow passes by the louver.

As depicted, cross-sections 1200 are examples of cross-sections that may be used to implement louvers 304. In this illustrative example, cross-sections 1200 include cross-section 1202, cross-section 1204, cross-section 1206, and cross-section 1208. These cross-sections are examples of airfoils that may be used for louvers 304. Cross-section 1210 is circular and cross-section 1212 is oval. The different cross-sections shown in cross-sections 1200 are presented merely as examples of shapes that may be used to implement louvers 304. Other types of cross-sectional shapes may be used in other illustrative examples. Further, louvers 304 may use all of the same type of cross-sectional shapes or may use different types of cross-sectional shapes depending the particular implementation. Different groupings of louvers in a section of a frame may have a different cross-section from other groupings of louvers in another portion of a frame or in a different frame. Further, the size of the cross sections may vary along the length of a louver.

The illustration of aircraft 100 and airflow management system 202 in FIGS. 1-12 are presented as illustrative examples of an apparatus for managing an airflow. These examples are not meant to limit the manner in which other illustrative examples may be implemented. Other illustrative examples may include, for example, a single frame, three frames, or some other suitable number of frames in a frame system. Further, although the movement of louvers 304 is shown using a movement system in the form of a motor and other components, the movement of louvers 304 may be performed by a human operator while aircraft 100 is on the ground in other examples.

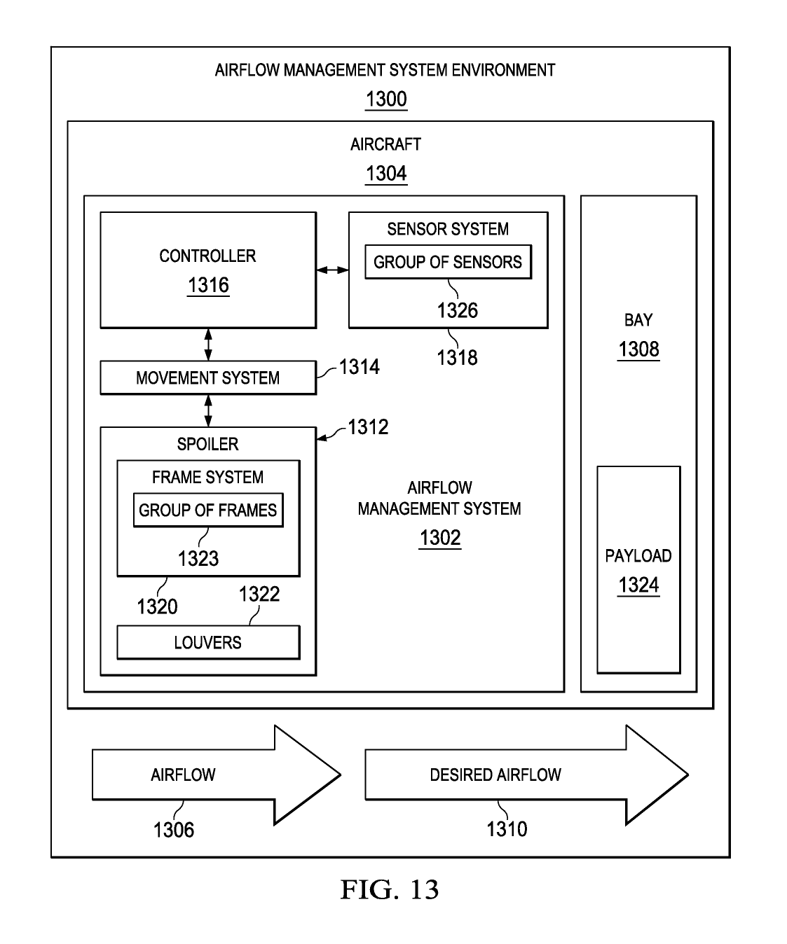

Turning now to FIG. 13, an illustration of an airflow management system is depicted in the form of a block diagram in accordance with an illustrative embodiment. Components in airflow management system environment 1300 may be implemented in an aircraft, such as aircraft 100 in FIG. 1. As depicted, airflow management system environment 1300 includes airflow management system 1302 that may be used in aircraft 1304 to change airflow 1306 moving relative to bay 1308 in aircraft 1304 to form desired airflow 1310. Bay 1308 may take different forms. For example, bay 1308 may be selected from one of a weapons bay, a cargo bay, a wheel well for landing gear, or some other suitable type of bay in aircraft 1304.

As depicted, airflow management system 1302 is comprised of a number of components. In this illustrative example, airflow management system 1302 includes spoiler 1312, movement system 1314, controller 1316, and sensor system 1318.

Spoiler 1312 is comprised of frame system 1320 and louvers 1322 that are physically associated with frame system 1320. As depicted, frame system 1320 may include group of frames 1323. As used herein, a “group of” when used with respect to items mean one or more items. For example, a group of frames 1323 is one or more frames.

Frame system 1320 is configured to move relative to bay 1308 in aircraft 1304. Louvers 1322 are configured to change airflow 1306 moving relative to bay 1308 when bay 1308 is open to form desired airflow 1310. Desired airflow 1310 results in at least one of a desired level of noise, preventing payload 1324 from becoming uncontrollable, or avoiding contact between aircraft 1304 and payload 1324 exiting aircraft 1304 from bay 1308. In the illustrative example, the uncontrollability may be, for example, inability to control the trajectory of payload 1324 as payload 1324 exits bay 1308 towards a target. The uncontrollability may occur even though contact is avoided when airflow 1306 is not desired airflow 1310.

In this illustrative example, desired airflow 1310 is a redirected laminar airflow moving relative to bay 1308. Louvers 1322 change airflow 1306 such that turbulence in airflow 1306 is reduced when bay 1308 is open. When using spoiler 1312, the turbulence is reduced in airflow 1306 as compared to not using spoiler 1312 or other currently available spoilers.

In this illustrative example, movement system 1314 is configured to move at least one of frame system 1320 or louvers 1322 within frame system 1320 to a desired orientation when frame system 1320 is outside of bay 1308. For example, movement system 1314 is configured to move frame system 1320 between a stowed position and an active position. In the active position, louvers 1322 change airflow 1306 relative to the bay in a desired manner after the louvers are in airflow 1306 outside of bay 1308 when frame system 1320 is in the active position.

Movement system 1314 may be configured to move frame system 1320 about a number of axes to move to the desired orientation when frame system 1320 is outside of bay 1308. Movement system 1314 also may be configured to move louvers 1322. For example, movement system 1314 may move louvers 1322 when aircraft 1304 is located in a location selected from at least one of on a ground or in air.

In the illustrative example, sensor system 1318 may include group of sensors 1326. Group of sensors 1326 is configured to detect the environment around the sensor and generate information used to control spoiler 1312. A sensor in group of sensors 1326 may be selected from one of a sound sensor, an airflow sensor, a vibration sensor, a pressure sensor, or some other suitable type of sensor.

As depicted, movement system 1314 may be configured to move louvers 1322 in response to changes in airflow 1306 to obtain desired airflow 1310 moving relative to bay 1308 when bay 1308 is open and desired airflow 1310 results in at least one of a desired level of noise, preventing payload 1324 from becoming uncontrollable, or avoiding contact between aircraft 1304 and payload 1324 exiting aircraft 1304 from bay 1308.

The illustration of airflow management system environment 1300 in FIG. 13 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, movement system 1314 and controller 1316 may be a single block. In another illustrative example, sensor system 1318 may be omitted from airflow management system environment 1300.

The different components shown in FIGS. 1-12 may be illustrative examples of how components shown in block form in FIG. 13 can be implemented as physical structures. Additionally, some of the components in FIGS. 1-12 may be combined with components in FIG. 13, used with components in FIG. 13, or a combination of the two.

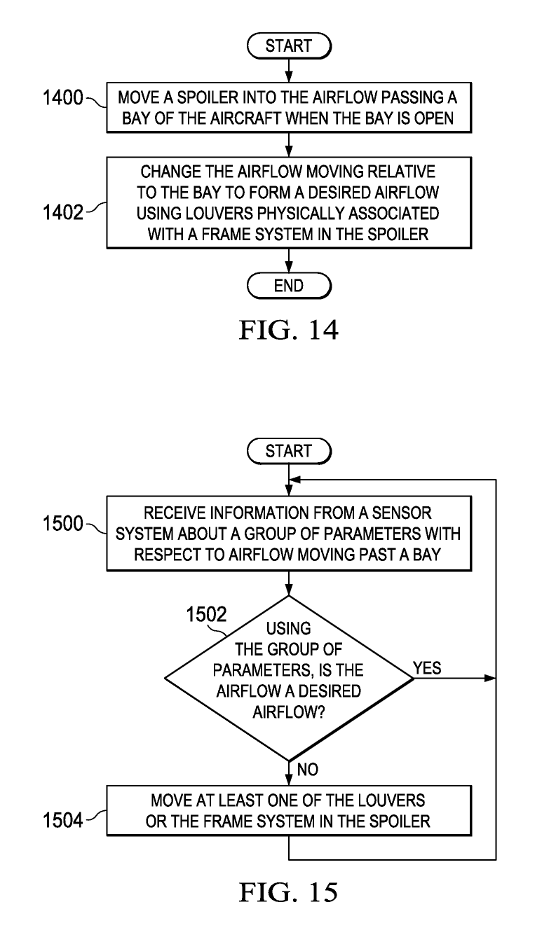

Turning next to FIG. 14, an illustration of a flowchart of a process for managing airflow for an aircraft is depicted in accordance with an illustrative embodiment. The process illustrated in FIG. 14 may be implemented in airflow management system environment 1300 in FIG. 13.

The process begins by moving a spoiler into the airflow passing a bay of the aircraft when the bay is open (operation 1400). The process then changes the airflow moving relative to the bay to form a desired airflow using louvers physically associated with a frame system in the spoiler (operations 1402) with the process terminating thereafter.

With reference next to FIG. 15, an illustration of a flowchart of a process for managing an airflow for an aircraft using an airflow management system is depicted in accordance with an illustrative embodiment. The process illustrated in FIG. 15 may be implemented using airflow management system environment 1300 in FIG. 13. This process may be performed dynamically during operation of an aircraft to maintain a desired airflow passing by a bay for an aircraft.

The process begins by receiving information from a sensor system about a group of parameters with respect to airflow moving past a bay (operation 1500). The parameters may be used to directly or indirectly identify characteristics about the airflow moving past a bay.

The sensor system may be sensor system 1318 in FIG. 13. The parameters may include at least one of an amount of turbulence in the bay, the level of sound in the bay, vibrations in a structure in a bay, vibrations in a structure in a portion of the aircraft, temperature, and other suitable parameters. The parameter selected may be based on those that may be used to identify whether airflow passing the bay is a desired airflow.

A determination is made as to whether the airflow is a desired airflow using the group of parameters (operation 1502). This determination may be made using a controller such as controller 1316 in FIG. 13.

If the airflow is not a desired airflow, at least one of the louvers or the frame system in the spoiler is moved (operation 1504) with the process then returning to operation 1500. In operation 1502, if the airflow is a desired airflow, the process also returns to operation 1500.

In this manner, the management of the airflow may be performed dynamically. In other words, adjustments may be made to the spoiler during operation of the aircraft to maintain a desired airflow.

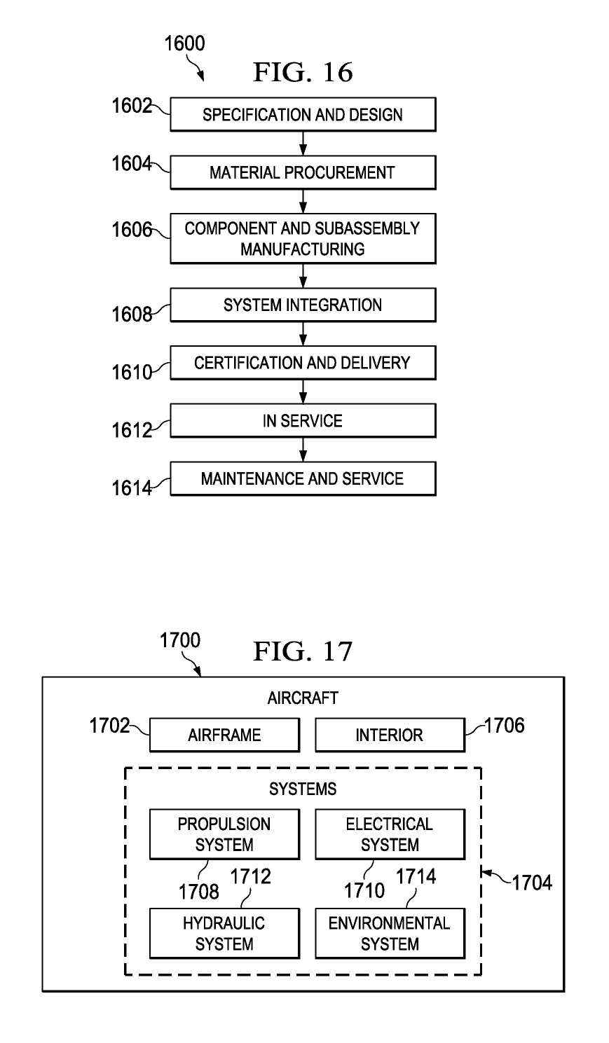

The illustrative embodiments of the present disclosure may be described in the context of aircraft manufacturing and service method 1600 as shown in FIG. 16 and aircraft 1700 as shown in FIG. 17. Turning first to FIG. 16, an illustration of an aircraft manufacturing and service method is depicted in the form of a block diagram in accordance with an illustrative embodiment. During pre-production, aircraft manufacturing and service method 1600 may include specification and design 1602 of aircraft 1700 in FIG. 17 and material procurement 1604.

During production, component and subassembly manufacturing 1606 and system integration 1608 of aircraft 1700 in FIG. 17 takes place. Thereafter, aircraft 1700 in FIG. 17 may go through certification and delivery 1610 in order to be placed in service 1612. While in service 1612 by a customer, aircraft 1700 in FIG. 17 is scheduled for routine maintenance and service 1614, which may include modification, reconfiguration, refurbishment, and other maintenance or service.

Each of the processes of aircraft manufacturing and service method 1600 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 17, an illustration of an aircraft is depicted in the form of a block diagram in which an illustrative embodiment may be implemented. In this example, aircraft 1700 is produced by aircraft manufacturing and service method 1600 in FIG. 16 and may include airframe 1702 with a plurality of systems 1704 and interior 1706. Examples of systems 1704 include one or more of propulsion system 1708, electrical system 1710, hydraulic system 1712, and environmental system 1714. Any number of other systems may be included. Although an example of an aircraft is shown, different illustrative embodiments may be applied to other industries, such as the automotive industry. Apparatuses and methods embodied herein may be employed during at least one of the stages of aircraft manufacturing and service method 1600 in FIG. 16.

In one illustrative example, components or subassemblies produced in component and subassembly manufacturing 1606 in FIG. 16 may be fabricated or manufactured in a manner similar to components or subassemblies produced while aircraft 1700 is in service 1612 in FIG. 16. As yet another example, one or more apparatus embodiments, method embodiments, or a combination thereof may be utilized during production stages, such as component and subassembly manufacturing 1606 and system integration 1608 in FIG. 16. One or more apparatus embodiments, method embodiments, or a combination thereof may be utilized while aircraft 1700 is in service 1612, during maintenance and service 1614 in FIG. 16, or both.

For example an airflow management system may be used during operation of aircraft 1700 when aircraft 1700 is in service 1612. In another illustrative example, an airflow management system may be added to aircraft 1700 during maintenance and service 1614.

The use of a number of the different illustrative embodiments may substantially expedite the assembly of aircraft 1700, reduce the cost of aircraft 1700, or both expedite the assembly of aircraft 1700 and reduce the cost of aircraft 1700. For example, the cost of aircraft 1700 may be reduced through fuel savings, reduced maintenance, or both in the illustrative examples.

Thus, the illustrative embodiments provide a method and apparatus for managing airflow for an aircraft. A spoiler in an airflow management system may change the direction of airflow such that the airflow passing through the spoiler becomes a desired airflow. The redirection in the illustrative examples is caused by louvers in a frame system for the spoiler. The redirection is in contrast to current spoilers that push the airflow around the spoiler in a manner that causes turbulence rather than redirecting the airflow as it passes through the spoiler.

With an illustrative embodiment, the recirculation of air in a bay of an aircraft may be reduced. Also, a payload may move a desired distance away from an aircraft before reaching an airstream in a manner that reduces the likelihood of at least one of a payload becoming uncontrollable or a payload contacting the aircraft again after being released. Also, the likelihood a payload having a desired trajectory to reach a target is increased. Additionally, using a spoiler in accordance with an illustrative embodiment may result in an ability to decrease the size of the spoiler that provides for a desired performance parameter, such as at least one of reduced noise or vibrations from a bay, preventing the separating payload from becoming uncontrollable, or avoiding contact of a payload exiting a bay with an aircraft during flight, or other suitable performance parameters.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An apparatus comprising:
a frame system configured to move relative to a bay in an aircraft; and
louvers physically associated with the frame system, wherein the louvers are configured to change an airflow moving relative to the bay when the bay is open to form a desired airflow.

2. The apparatus of claim 1, wherein the desired airflow results in at least one of a desired level of noise, preventing a payload from becoming uncontrollable, or avoiding contact between the aircraft and the payload exiting the bay of the aircraft in flight.

3. The apparatus of claim 1, wherein the desired airflow is a redirected laminar airflow moving relative to the bay.

4. The apparatus of claim 1, wherein in being configured to change the airflow moving relative to the bay when the bay is open to form the desired airflow, the louvers change the airflow such that turbulence in the airflow is reduced when the bay is open.

5. The apparatus of claim 1, wherein the frame system is configured to move between a stowed position and an active position and the louvers change the airflow relative to the bay in a desired manner after the louvers are in the airflow outside of the bay when the frame system is in the active position.

6. The apparatus of claim 1 further comprising:
a movement system configured to move at least one of the frame system or the louvers within the frame system to a desired orientation when the frame system is outside of the bay.

7. The apparatus of claim 6, wherein the frame system is configured to move about a number of axes to move to the desired orientation when the frame system is outside of the bay.

8. The apparatus of claim 6, wherein the louvers are moved when the aircraft is located in a location selected from at least one of on a ground or in air.

9. The apparatus of claim 6, wherein the louvers are configured to move in response to changes in the airflow to obtain the desired airflow moving relative to the bay when the bay is open and the desired airflow results in at least one of a desired level of noise, preventing a payload from becoming uncontrollable, or avoiding contact between the aircraft and the payload exiting the bay of the aircraft in flight.

10. The apparatus of claim 6, wherein the louvers are moved based on a payload in the bay to be separated from the aircraft.

11. The apparatus of claim 1, wherein the bay is selected from one of a weapons bay, a cargo bay, and a wheel well for landing gear.

12. An aircraft airflow management system comprising:
a group of frames configured to move between a stowed position in a bay of an aircraft and an active position outside the bay of the aircraft; and
louvers physically associated with the group of frames, wherein the louvers are configured to change an airflow relative to the bay after the louvers are in the airflow outside of the bay in a desired manner when the bay is open to form a desired airflow and the group of frames are in the active position and wherein the desired airflow results in at least one of a desired level of noise, preventing a payload from becoming uncontrollable, or avoiding contact between the aircraft and the payload exiting the bay of the aircraft in flight.

13. The aircraft airflow management system of claim 12, wherein the group of frames is configured to move about a number of axes to move to a desired orientation when a frame system is outside of the bay.

14. The aircraft airflow management system of claim 12, wherein the louvers are configured to move in response to changes in the airflow to obtain a desired airflow moving relative to the bay when the bay is open.

15. The aircraft airflow management system of claim 12, wherein the desired airflow is a redirected laminar airflow moving relative to the bay.

16. The aircraft airflow management system of claim 12, wherein in being configured to change the airflow moving relative to the bay when the bay is open to form the desired airflow, an increase in turbulence in the airflow is reduced.

17. A method for managing an airflow for an aircraft, the method comprising:
moving a spoiler into the airflow passing a bay of the aircraft when the bay is open; and
changing the airflow moving relative to the bay to form a desired airflow using louvers physically associated with a frame system in the spoiler.

18. The method of claim 17 further comprising:
moving the louvers within the frame system to a desired orientation when the frame system is outside of the bay.

19. The method of claim 17 further comprising:
moving the louvers within the frame system to a desired orientation prior to flight of the aircraft.

20. The method of claim 17 further comprising:
moving the frame system to a desired orientation when the frame system is in an active position outside of the bay, wherein the frame system is configured to move about a number of axes to move to the desired orientation when the frame system is outside of the bay.
